(19) United States
(12) Patent Application Publication
(10) Pub. No.: US 2026/0129208 A1
(43) Pub. Date: May 7, 2026

(54) IMAGE PROCESSING METHOD BASED ON GLOBAL MOTION ESTIMATION AND DEVICE USING THE SAME

(71) Applicant: SAMSUNG ELECTRONICS CO., LTD., Suwon-si (KR)

(72) Inventors: Seunghoon JEE, Suwon-si (KR); Paul OH, Suwon-si (KR); Dokwan OH, Suwon-si (KR); Junhee LEE, Suwon-si (KR); Chansol HWANG, Suwon-si (KR)

(73) Assignee: SAMSUNG ELECTRONICS CO., LTD., Suwon-si (KR)

(21) Appl. No.: 19/097,449

(22) Filed: Apr. 1, 2025

(30) Foreign Application Priority Data
Nov. 6, 2024 (KR) 10-2024-0156411

(51) Int. Cl. H04N 19/139; H04N 19/172; H04N 19/176; H04N 19/517; H04N 19/527; H04N 23/68

(52) U.S. Cl. CPC H04N 19/139; H04N 19/172; H04N 19/527; H04N 23/681; H04N 23/683; H04N 19/176; H04N 19/517

(57) ABSTRACT

A method of image processing based on global motion estimation including: estimating global motion parameters corresponding to components of a global motion between a current image frame and a reference image frame by executing a global motion estimation model comprising one or more neural networks that input the current image frame and the reference image frame; generating a geometric transformation matrix by combining the global motion parameters; and generating at least one of an output image and an output video using the geometric transformation matrix.

### CROSS-REFERENCE TO RELATED APPLICATIONS

This application claims the benefit under 35 USC § 119(a) of Korean Patent Application No. 10-2024-0156411, filed on Nov. 6, 2024, in the Korean Intellectual Property Office, the entire disclosure of which is incorporated herein by reference for all purposes.

### BACKGROUND

### 1. Field

The following description relates to an image processing method based on global motion estimation and a device using the same.

### 2. Description of Related Art

In a process of generating an image or a video, image signal processing to resolve degradation of the image or video compression to efficiently store a video file may be performed. The image signal processing or video compression may improve the quality of the image or the size of the video based on the correlation between frames. The correlation between frames may be derived based on motion estimation that compares the frames block-wise. The motion estimation may be performed in a predetermined search range. When the search range is restricted, a block matching rate may be improved by considering a global motion that occurs due to a camera motion, etc. Furthermore, the global motion may be used for image signal processing such as image stabilization.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

According to an aspect of the disclosure, a method of image processing based on global motion estimation includes estimating global motion parameters corresponding to components of a global motion between a current image frame and a reference image frame by executing a global motion estimation model comprising one or more neural networks that input the current image frame and the reference image frame; generating a geometric transformation matrix by combining the global motion parameters; and generating at least one of an output image and an output video using the geometric transformation matrix.

According to an aspect of the disclosure, an electronic device includes: a camera configured to generate a current image frame and a reference image frame; a memory storing one or more instructions; a video codec; and at least one processor operatively coupled to the memory, the camera, and the video codec, in which the one or more instructions, when executed by the at least one processor, cause the electronic device to: store a global motion estimation model based on a neural network and estimate global motion parameters corresponding to components of a global motion between the current image frame and the reference image frame by executing the global motion estimation model comprising one or more neural networks that input the reference image frame; control the video codec to generate a geometric transformation matrix by combining the global motion parameters; and generate an output video using the geometric transformation matrix.

According to an aspect of the disclosure, an electronic device includes: a camera configured to generate a current image frame and a reference image frame; a memory storing one or more instructions; an image signal processor (ISP); and at least one processor operatively coupled to the memory, the camera, in which the one or more instructions, when executed by the at least one processor, cause the electronic device to: store a global motion estimation model based on a neural network and estimate global motion parameters corresponding to components of a global motion between the current image frame and the reference image frame by executing the global motion estimation model comprising one or more neural networks that input the reference image frame; control the ISP to generate a geometric transformation matrix by combining the global motion parameters; and generate an output video using the geometric transformation matrix.

Other features and aspects will be apparent from the following detailed description, the drawings, and the claims.

### BRIEF DESCRIPTION OF THE DRAWINGS

FIG. 1 is a diagram illustrating an example of operations of generating global motion parameters and a geometric transformation matrix using a global motion estimation model, according to one or more embodiments.

FIG. 2 is a diagram illustrating an example of operations of generating an affine transformation matrix as a geometric transformation matrix, according to one or more embodiments.

FIG. 3 is a diagram illustrating an example of a global motion estimation model including sub-models, according to one or more embodiments.

FIG. 4 is a diagram illustrating operations of generating a homography transformation matrix as a geometric transformation matrix, according to one or more embodiments.

FIG. 5 is a diagram illustrating an example of training and inference stages of a global motion estimation model, according to one or more embodiments.

FIG. 6 is a diagram illustrating an example of a frame prediction model used for training a global motion estimation model, according to one or more embodiments.

FIG. 7 is a diagram illustrating an example of a motion kernel estimation model of a frame prediction model, according to one or more embodiments.

FIG. 8 is a diagram illustrating an example of an unfolding operation of a motion kernel estimation model, according to one or more embodiments.

FIG. 9 is a block diagram illustrating an exemplary configuration of an electronic device, according to one or more embodiments.

FIG. 10 is a block diagram illustrating another exemplary configuration of an electronic device, according to one or more embodiments.

FIG. 11 is a flowchart illustrating an example of an image processing method based on global motion estimation, according to one or more embodiments.

FIG. 12 is a block diagram illustrating another exemplary configuration of an electronic device, according to one or more embodiments.

Throughout the drawings and the detailed description, unless otherwise described or provided, the same drawing reference numerals will be understood to refer to the same elements, features, and structures. The drawings may not be to scale, and the relative size, proportions, and depiction of elements in the drawings may be exaggerated for clarity, illustration, and convenience.

### DETAILED DESCRIPTION

The following detailed structural or functional description is provided as an example only and various alterations and modifications may be made to the examples. Here, the examples are not construed as limited to the disclosure and should be understood to include all changes, equivalents, and replacements within the idea and the technical scope of the disclosure.

Terms, such as first, second, and the like, may be used herein to describe components. Each of these terminologies is not used to define an essence, order or sequence of a corresponding component but used merely to distinguish the corresponding component from other component(s). For example, a first component may be referred to as a second component, and similarly the second component may also be referred to as the first component.

It should be noted that if one component is described as being “connected”, “coupled”, or “joined” to another component, a third component may be “connected”, “coupled”, and “joined” between the first and second components, although the first component may be directly connected, coupled, or joined to the second component.

The singular forms “a,” “an,” and “the” are intended to include the plural forms as well, unless the context clearly indicates otherwise. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or groups thereof.

As used herein, “at least one of A and B”, “at least one of A, B, or C,” and the like, each of which may include any one of the items listed together in the corresponding one of the phrases, or all possible combinations thereof.

Unless otherwise defined, all terms, including technical and scientific terms, used herein have the same meaning as commonly understood by one of ordinary skill in the art to which this disclosure pertains. It will be further understood that terms, such as those defined in commonly-used dictionaries, should be interpreted as having a meaning that is consistent with their meaning in the context of the relevant art and will not be interpreted in an idealized or overly formal sense unless expressly so defined herein.

Hereinafter, embodiments will be described in detail with reference to the accompanying drawings. When describing the embodiments with reference to the accompanying drawings, like reference numerals refer to like elements and a repeated description related thereto will be omitted.

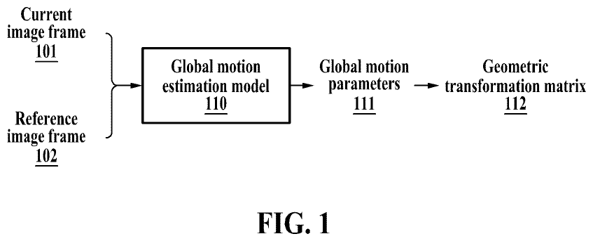

FIG. 1 is a diagram illustrating an example of operations of generating global motion parameters and a geometric transformation matrix using a global motion estimation model, according to one or more embodiments. Referring to FIG. 1, a global motion estimation model 110 may estimate global motion parameters 111 corresponding to components of a global motion between a current image frame 101 and a reference image frame 102 based on the current image frame 101 and the reference image frame 102. The global motion estimation model 110 may be based on a neural network model and may be trained to estimate the global motion parameters 111 based on the current image frame 101 and the reference image frame 102. For example, the global estimation model 110 may comprise one or more neural networks that are trained to estimate the global estimation parameters 111 based on one or more frames such as the current image frame 101 and the reference image frame 102. A neural network may include a deep neural network (DNN), and there are, for example, a convolutional neural network (CNN), a deep neural network (DNN), a recurrent neural network (RNN), a restricted Boltzmann Machine (RBM), a deep belief network (DBN), a bidirectional recurrent deep neural network (BRDNN), a generative adversarial network (GAN), or deep Q-networks, etc., but the disclosure is not limited to the aforementioned examples

The current image frame 101 and the reference image frame 102 may correspond to a portion of image frames of an image sequence of a video. The current image frame 101 may be an image frame at a current time point and the reference image frame 102 may be an image frame at a previous time point, but the example is not limited thereto. For example, the reference image frame 102 may be a synthetic image frame generated using a mathematical model or a machine learning model, or a composite image created from frames captured by multiple cameras or sensors at a same time or multiple different times.

The image frames may be compressed as a video using a video codec. Motion estimation and motion compensation may be performed when encoding by a video codec. According to the motion estimation, a motion vector corresponding to a motion between blocks of the current image frame 101 and blocks of the reference image frame 102 may be estimated. A search range may be determined for the reference image frame 102 based on a block position of the current image frame 101 and block matching between the current image frame 101 and the reference image frame 102 may be performed while moving the blocks in the search range. For example, a block in the current image frame 101 may be matched with a block in the reference image frame 102 based on the estimated motion. The motion vector may be determined based on the matching blocks of the current image frame 101 and the reference image frame 102 according to block matching. During the motion compensation, an image frame may be predicted by applying the motion vector to the reference image frame 102. Data required for storing the current image frame 101 may be saved using a predicted image frame.

A computational complexity of the motion estimation may depend on the size of the search range. As the search range increases, the computational complexity may increase. The reduction of the search range may reduce a block matching rate and a video compression rate. In a device environment, such as a mobile device to which a system on chip (SoC) is applied, the size of the search range may be limited. In this case, a global motion may be used. For example, when capturing a video using a camera, a global motion may occur due to the movement of the camera. The global motion may appropriately move a search starting point for block matching. The global motion may improve the block matching rate and the video compression rate without increasing the search range.

In one or more examples, the global motion may be used for a processing process of an image signal processor (ISP). For example, the global motion may be used for at least one of stabilization, noise reduction, high dynamic range (HDR), deblur, and frame rate-up conversion (FRUC). For example, a camera motion may be estimated based on the global motion and stabilization may be performed to offset the global motion.

For vision-based global motion estimation, feature point search, corresponding point search, and random sample consensus (RANSAC) based on the current image frame 101 and the reference image frame 102 may be performed. An optical flow may be derived by the feature point search and an outlier may be removed by RANSAC. The vision-based global motion estimation may require high computational complexity. For example, the computational complexity of RANSAC may not be uniform and may be significantly high in some cases.

When using the vision-based global motion estimation for video encoding, real-timeness (e.g., 30 frame per second (FPS)) may not be guaranteed in an SoC-based device environment, such as a mobile device. According to one or more embodiments, real-timeness may be secured using the neural network-based global motion estimation model 110. For example, real-timeness may be secured by downscaling the size of the current image frame 101 and the reference image frame 102, and/or appropriately adjusting the number of network parameters of the global motion estimation model 110. In one or more examples, the term real-timeness may refer to performing one or more operations within a predetermined amount of time.

The global motion estimation model 110 may estimate the global motion parameters 111 corresponding to the global motion. A geometric transformation matrix 112 may be generated by combining the global motion parameters 111. The geometric transformation matrix 112 may represent a global motion. For example, geometric transformation may include warping. For example, the geometric transformation matrix may include an affine transformation matrix and/or a homography transformation matrix. For example, the affine transformation matrix may be used for video encoding and the homography transformation matrix may be used for image signal processing (e.g., image stabilization), but the example is not limited thereto. In one or more examples, matrix transformation warping may refer to a technique that uses a matrix to change the coordinates of an image, allowing the image to be viewed from a different perspective. In one or more examples, a homography matrix is a matrix (e.g., N×N matrix) that transforms points from one plane to another. For example, the homography matrix may transform coordinates form an original plane to a new plane.

According to one or more embodiments, the geometric transformation matrix 112 may not be directly estimated by the global motion estimation model 110. According to one or more embodiments, the global motion parameters 111 corresponding to components of the global motion may be estimated by the global motion estimation model 110 and the geometric transformation matrix 112 may be determined by combining the global motion parameters 111.

The components of the global motion may be defined in various aspects. For example, the components of the global motion may include a translation component, a rotation component, a scale component, and a shear component. In this case, the global motion parameters 111 may include a translation parameter, a rotation parameter, a scale parameter, and a shear parameter. In this case, the affine transformation matrix may be determined by a combination of the translation parameter, the rotation parameter, the scale parameter, and the shear parameter.

For example, the components of the global motion may include a roll angle component, a pitch angle component, and a yaw angle component. In this case, the global motion parameters 111 may include a roll angle parameter, a pitch angle parameter, and a yaw angle parameter. In this case, the homography transformation matrix may be determined by a combination of the roll angle parameter, the pitch angle parameter, and the yaw angle parameter.

The components of the global motion may have different sensitivities. For example, during the affine transformation, the rotation component may have high sensitivity compared to the translation component. When elements of the geometric transformation matrix 112 are directly inferred by the global motion estimation model 110, the sensitivity difference may not be considered. According to one or more embodiments, since the global motion parameters 111 corresponding to the components of the global motion are explicitly and individually estimated, the global motion estimation model 110 may be optimized by considering the sensitivities of the components during a training process.

One or more function values may be determined by substituting one or more global motion parameters 111 into one or more functions. For example, the function may include a trigonometric function. The global motion parameters 111 may be combined based on operations between the global motion parameters 111, operations between the global motion parameters 111 and one or more function values, operations between a plurality of function values of the one or more function values, or a combination thereof. Based on the combination, the elements of the geometric transformation matrix 112 may be determined.

For example, a predetermined combination of the global motion parameters 111 may form a relational expression between the global motion parameters 111. The relational expression may compel a relationship between the global motion parameters 111 in the geometric transformation matrix 112. In the training process, the global motion estimation model 110 may be optimized under the relationship.

At least one of an output image and an output video may be generated using the geometric transformation matrix 112. For example, the output image may be generated by driving an ISP using the geometric transformation matrix 112. For example, the image stabilization may be performed based on the geometric transformation matrix 112. For example, the output video may be generated by encoding the current image frame 101 and the reference image frame 102 using the geometric transformation matrix 112.

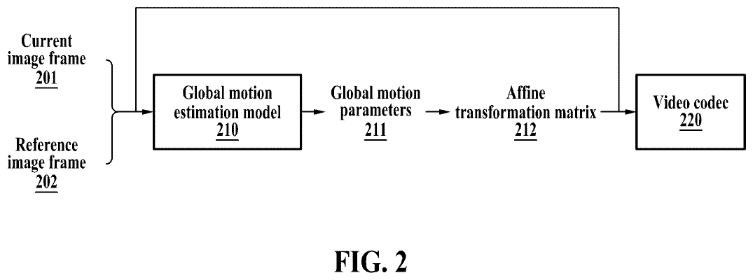

FIG. 2 is a diagram illustrating an example of operations of generating an affine transformation matrix as a geometric transformation matrix, according to one or more embodiments. Referring to FIG. 2, an electronic device may estimate global motion parameters 211 corresponding to components of a global motion between a current image frame 201 and a reference image frame 202 by executing a global motion estimation model 210 based on the current image frame 201 and the reference image frame 202.

The electronic device may generate an affine transformation matrix 212 by combining the global motion parameters 211. The global motion parameters 211 may include a translation parameter, a rotation parameter, a scale parameter, and a shear parameter. The electronic device may determine one or more function values by substituting one or more global motion parameters 211 into one or more functions. For example, the function may include a trigonometric function. The electronic device may determine elements of the affine transformation matrix 212 by combining the global motion parameters 211 based on operations between the global motion parameters 211, operations between the global motion parameters 211 and one or more function values, operations between a plurality of function values of the one or more function values, or a combination thereof.

A video codec 220 may support modes of various global motion types. The number of global motion parameters 211, a type of the global motion parameters 211, and a combination of the global motion parameters 211 may be determined based on the modes of the video codec 220. For example, the modes may include at least one of a translation mode using a global translation motion, a rotation mode using a global rotation motion, a zoom mode using a global zoom motion, a rotation and zoom mode using global rotation and global zoom, and an affine mode using a global translation motion, a global rotation motion, a global zoom motion, and a global shear motion. The zoom may correspond to a scale.

For example, in the rotation and zoom mode, the global motion parameters 211 may include tₓ, t_{y}, θ, and s. The parameter tₓ may be a translation parameter indicating a global motion translation motion in the x-axis direction, the parameter t_{y} may be a translation parameter indicating a global translation motion in the y-axis direction, θ may be a rotation parameter indicating a global rotation motion, and s may be a scale parameter indicating a global zoom motion. In the rotation and zoon mode, the affine transformation matrix 212 may be expressed by Equation 1 below.

$$[ \begin{matrix}s * cos θ & - s * sin θ & {t}_{x} \\ s * sin θ & s * cos θ & {t}_{y}\end{matrix} ] \qquad [ Equation 1 ]$$

In the affine mode, the global motion parameters 211 may include tₓ, t_{y}, θ, s, sₓ, and s_{y}. sₓ may be a shear parameter indicating a global shear motion in the x-axis direction and s_{y} may be a shear parameter indicating a global shear motion in the y-axis direction. In the affine mode, the affine transformation matrix 212 may be expressed by Equation 2 below.

$$[ \begin{matrix}s * cos θ & - {s}_{x} * sin θ & {t}_{x} \\ s * sin θ & {s}_{y} * cos θ & {t}_{y}\end{matrix} ] \qquad [ Equation 2 ]$$

The number of elements of the affine transformation matrix 212 used by the video codec 220 may be determined based on each mode. For example, two elements may be used in the translation mode, four elements may be used in the rotation mode, four elements may be used in the zoom mode, six elements may be used in the rotation and zoom mode, and six elements may be used in the affine mode. The elements that are not used for the affine transformation matrix 212 in each mode may be filled with 1 or 0. According to one or more embodiments, sub-models of the global motion estimation model 210 corresponding to one or more modes may exist. For example, sub-models corresponding to respective modes may exist. The sub-models may be independently trained based on the global motion parameters 211 used in a corresponding mode and the affine transformation matrix 212. The sub-models are further described below.

The electronic device may generate an output video using the affine transformation matrix 212. For example, the electronic device may input the current image frame 201, the reference image frame 202, and the affine transformation matrix 212 to the video codec 220. The video codec 220 may support the affine transformation matrix 212. For example, the video codec 220 may be AV1 or VVC (Versatile Video Coding), but the example is not limited thereto.

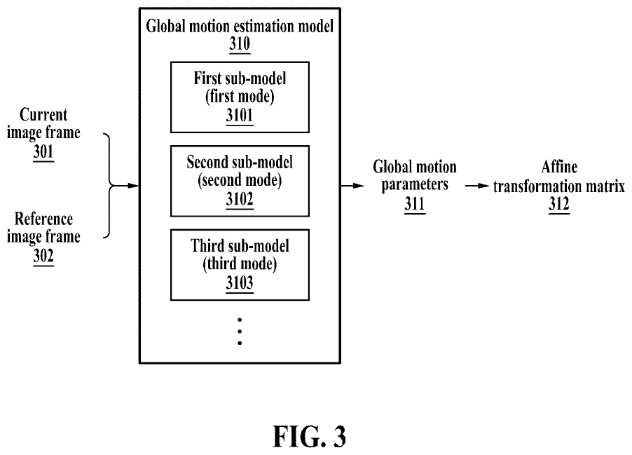

FIG. 3 is a diagram illustrating an example of a global motion estimation model including sub-models, according to one or more embodiments. Referring to FIG. 3, a global motion estimation model 310 may estimate global motion parameters 311 based on a current image frame 301 and a reference image frame 302. The global motion estimation model 310 may include sub-models such as first to third sub-models 3101 to 3103. The sub-models may correspond to at least one of a translation mode, a rotation mode, a zoom mode, a rotation and zoom mode, and an affine mode. In one or more examples, each sub-model may be implemented by one or more neural networks.

An electronic device may estimate the global motion parameters 311 by executing the sub-model corresponding to a current mode selected from the translation mode, the rotation mode, the zoom mode, the rotation and zoom mode, and the affine mode. The sub-models may estimate different global motion parameter sets. The different global motion parameter sets may have different numbers of global motion parameters 311 and/or different types of global motion parameters 311. An affine transformation matrix 312 of different modes may be determined based on a different combination of different global motion parameter sets.

For example, in the rotation and zoom mode, the first sub-model 3101 may be used. The global motion parameters 311 of the first sub-model 3101 may include the parameters tₓ, t_{y}, θ, and s. In one or more examples, the affine transformation matrix 312 corresponding to Equation 1 above may be determined. In the affine mode, the second sub-model 3102 may be used. The global motion parameters 311 of the second sub-model 3102 may include the parameters tₓ, t_{y}, θ, s, sₓ, and s_{y}. In this case, the affine transformation matrix 312 corresponding to Equation 2 above may be determined.

The sub-models may be independently trained in corresponding modes. For example, in the rotation and zoom mode, the first sub-model 3101 may be trained based on the global motion parameters 311 of the first sub-model 3101 and the affine transformation matrix 312. In the affine mode, the second sub-model 3102 may be trained based on the global motion parameters 311 of the second sub-model 3102 and the affine transformation matrix 312.

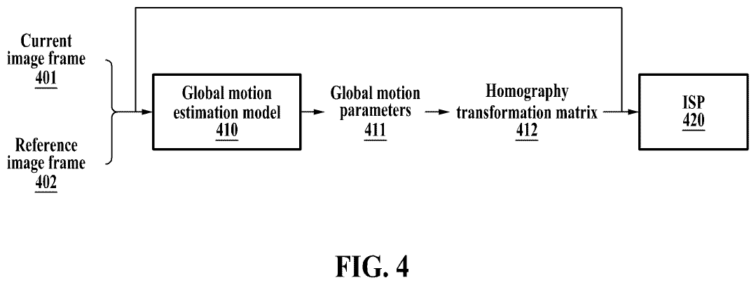

FIG. 4 is a diagram illustrating operations of generating a homography transformation matrix as a geometric transformation matrix, according to one or more embodiments. Referring to FIG. 4, an electronic device may estimate global motion parameters 411 corresponding to components of a global motion between a current image frame 401 and a reference image frame 402 by executing the global motion estimation model 210 based on the current image frame and the reference image frame.

The electronic device may generate a homography transformation matrix 412 by combining the global motion parameters 411. The global motion parameters 411 may include a roll angle parameter, a pitch angle parameter, and a yaw angle parameter. The electronic device may determine one or more function values by substituting one or more global motion parameters 411 into one or more functions. For example, the function may include a trigonometric function. The electronic device may determine elements of the homography transformation matrix 412 by combining the global motion parameters 411 based on operations between the global motion parameters 411, operations between the global motion parameters 411 and one or more function values, operations between a plurality of function values of the one or more function values, or a combination thereof. The homography transformation matrix 412 may be expressed by Equation 3 below.

$$[ \begin{matrix}cos α cos β & \begin{matrix}cos α sin β sin γ - \\ sin α cos γ\end{matrix} & \begin{matrix}cos α sin β cos γ + \\ sin α sin γ\end{matrix} \\ sin α cos β & \begin{matrix}sin α sin β sin γ + \\ cos α cos γ\end{matrix} & \begin{matrix}sin α sin β cos γ - \\ cos α sin γ\end{matrix} \\ - sin β & cos β sin γ & cos β cos γ\end{matrix} ] \qquad [ Equation 3 ]$$

The parameter α may be a yaw angle parameter, the parameter β may be a pitch angle parameter, and the parameter γ may be a roll angle parameter. A first person video motion may be highly sensitive to a three-dimensional (3D) rotation motion of a camera and the importance of the 3D rotation motion may be significantly high compared to other motions, such as translation. Accordingly, the homography transformation matrix 412 may be defined based on α, β, and γ. However, the example is not limited thereto and the homography transformation matrix 412 may be defined based on an additional parameter.

Transformation and invertible transformation may be performed between the homography transformation matrix 412 and a 3D rotation matrix. The 3D rotation matrix may be expressed by Equation 4 below. In this case, the positive characteristics of the homography transformation matrix 412 may remain.

$$\begin{matrix}R = {R}_{z} ( α ) {R}_{y} ( β ) {R}_{x} ( γ ) \\ = [ \begin{matrix}cos α & - sin α & 0 \\ sin α & cos α & 0 \\ 0 & 0 & 1\end{matrix} ] [ \begin{matrix}cos β & 0 & sin β \\ 0 & 1 & 0 \\ - sin β & 0 & cos β\end{matrix} ] \text{} [ \begin{matrix}1 & 0 & 0 \\ 0 & cos γ & - sin γ \\ 0 & sin γ & cos γ\end{matrix} ]\end{matrix} \qquad [ Equation 4 ]$$

In Equation 4, a first matrix may denote a yaw matrix, a second matrix may denote a pitch matrix, and a third matrix may denote a roll matrix.

The electronic device may generate an output image using the homography transformation matrix 412. For example, the electronic device may input the current image frame 401, the reference image frame 402, and the homography transformation matrix 412 to an ISP 420. The ISP 420 may perform image signal processing, such as image stabilization, based on the homography transformation matrix 412. For example, the ISP 420 may perform image stabilization by correcting a difference between a global motion and a target motion. The global motion may correspond to an actual motion and the target motion may be obtained by smoothing the global motion. The global motion may be determined based on the homography transformation matrix 412.

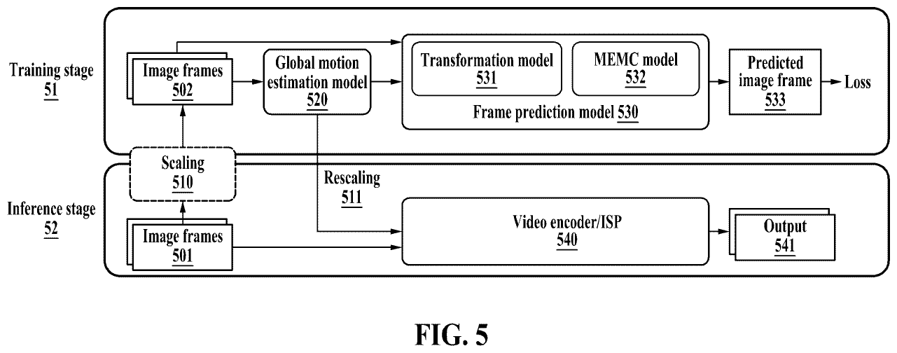

FIG. 5 is a diagram illustrating an example of training and inference stages of a global motion estimation model, according to one or more embodiments. Referring to FIG. 5, in a training stage 51, image frames 502 may be input to a global motion estimation model 520. The image frames 502 in the training stage 51 may include a current training image frame and a reference training image frame. The global motion estimation model 520 may estimate global motion parameters corresponding to components of a global motion between the image frames 502.

The size of the image frames 502 and the number of parameters of the global motion estimation model 520 may be determined for real-timeness of video encoding. The determined size and the determined number of parameters may be referred to as a target size and the number of target parameters. For example, the computational complexity may be determined to generate a 30-FPS video without latency and the target size and the number of target parameters may be determined to perform video encoding based on the global motion parameters in the corresponding computational complexity.

A frame prediction model 530 may include a transformation model 531 and a motion estimation and motion compensation (MEMC) model 532. The frame prediction model 530 may mimic operations of a video encoder and/or an ISP 540. A geometric transformation matrix may be generated by combining the global motion parameters. The transformation model 531 may generate a transformed reference training image frame by performing geometric transformation on the reference training image frame based on the geometric transformation matrix. The MEMC model 532 may generate a predicted image frame 533 by performing motion estimation and motion compensation based on the current training image frame and the transformed reference training image frame. The predicted image frame 533 may be a predicted current training image frame.

A loss may be determined based on a difference between the current training image frame and the predicted image frame 533. The frame prediction model 530 may be implemented as a neural network-based differentiable model. The global motion estimation model 520 may be trained to reduce the loss. As the accuracy of global motion estimation increases, the difference between the current training image frame and the predicted image frame 533 may decrease. The global motion estimation model 520 may be optimized to increase the accuracy of global motion estimation using a loss defined based on the difference between the current training image frame and the predicted image frame 533. Since the loss is determined based on the global motion parameters and the geometric transformation matrix, the global motion parameters and the geometric transformation matrix may be optimized in the training stage 51.

Based on the training stage 51, the global motion estimation model 520 may have an ability to estimate global motion parameters corresponding to a global motion between the image frames 502. When the training stage 51 is terminated with sufficient iteration, an inference stage 52 using the global motion estimation model 520 may be performed.

In the inference stage 52, image frames 501 of an original size may be scaled to the image frames 502 of a target size by scaling 510. The scaling 510 may be downscaling. The target size may be less than the original size. In the inference stage 52, the image frames 501 may include a current image frame and a reference image frame. In the inference stage 52, the image frames 502 may include a scaled current image frame and a scaled reference image frame. The global motion estimation model 520 may be executed based on the image frames 502 and may generate global motion parameters.

The global motion parameters may be reconstructed to correspond to the original size by rescaling 511. The reconstructed global motion parameters may be input to the video encoder and/or the ISP 540. The video encoder and/or the ISP 540 may generate an output 541 corresponding to the image frames 501 based on the reconstructed global motion parameters. For example, the output 541 may include at least one of an output image and an output video.

According to one or more embodiments, the target size may be adjusted to guarantee real-timeness of video encoding. According to one or more embodiments, sub-models of the global motion estimation model 520 corresponding to each target size may exist. For example, the sub-models may include a first sub-model corresponding to a first target size and a second sub-model corresponding to a second target size. The first target size may be greater than the second target size.

In the training stage 51, the first sub-model may be trained to estimate the global motion parameters based on the image frames 502 of the first target size. The second sub-model may be trained to estimate the global motion parameters based on the image frames 502 of the second target size. In the inference stage 52, the image frames 501 of the original size may be scaled to the image frames 502 of the first target size by the scaling 510. In this case, the first sub-model of the global motion estimation model 520 may be used to estimate the global motion parameters.

When the real-timeness is not guaranteed due to the device environment, the second target size may be used instead of the first target size. In this case, the image frames 501 of the original size may be scaled to the image frames 502 of the second target size by the scaling 510. The second sub-model of the global motion estimation model 520 may be used to estimate the global motion parameters. When the second target size is used instead of the first target size, the computational complexity may decrease and thereby the real-timeness may be guaranteed by a second target size in a device environment in which the real-timeness is not guaranteed by a first target size.

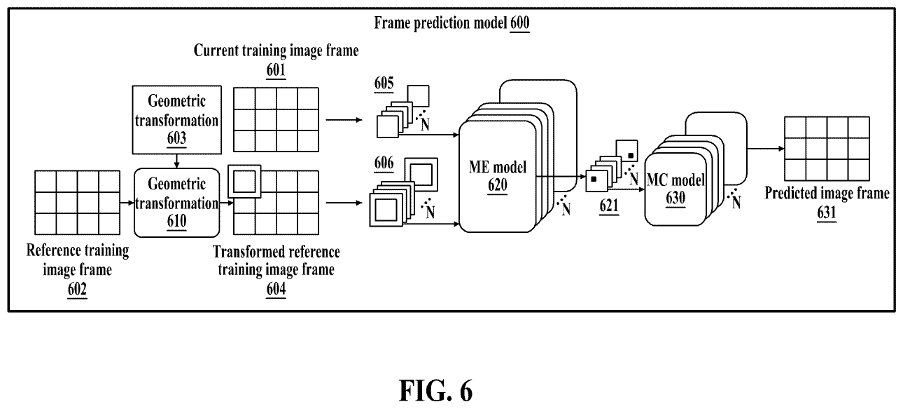

FIG. 6 is a diagram illustrating an example of a frame prediction model used for training a global motion estimation model, according to one or more embodiments. Referring to FIG. 6, a frame prediction model 600 may include an ME model 620 and an MC model 630. The ME model 620 and the MC model 630 may be implemented as a neural network-based differentiable model. A geometric transformation matrix 603 corresponding to a global motion between a current image frame 601 and a reference training image frame 602 may be estimated by a global motion estimation model. Geometric transformation 610 may be performed on the reference training image frame 602 based on the geometric transformation matrix 603. A transformed reference training image frame 604 may be generated by the geometric transformation 610.

The ME model 620 may determine blocks 605 by dividing the current image frame 601 into a first size. The number of blocks 605 may be N. The ME model 620 may determine search ranges 606 of a second size by dividing the transformed reference training image frame 604. The ME model 620 may divide the transformed reference training image frame 604 into blocks of the first size and may determine the search ranges 606 of the second size including the blocks in a center. The number of the search ranges 606 may be N. The blocks 605 and the search ranges 606 may have a correspondence relationship. The ME model 620 may perform motion estimation based on the blocks 605 and the search ranges 606. The ME model 620 may generate motion kernels 621 corresponding to an estimated motion. The ME model 620 may include N sub-models and N motion kernels 621 may be generated in parallel using the N sub-models.

The MC model 630 may generate a predicted image frame 631 by applying the motion kernels 621 to blocks of the transformed reference training image frame 604. For example, the MC model 630 may generate the predicted image frame 631 by performing a convolution operation between the motion kernels 621 and the blocks of the transformed reference training image frame 604. The convolution operation may correspond to a differentiable operation. The MC model 630 may have differentiable characteristics due to the convolution operations based on the motion kernels 621. The MC model 630 may include N sub-models and convolution operations between N blocks and N motion kernels 621 may be performed in parallel using the N sub-models.

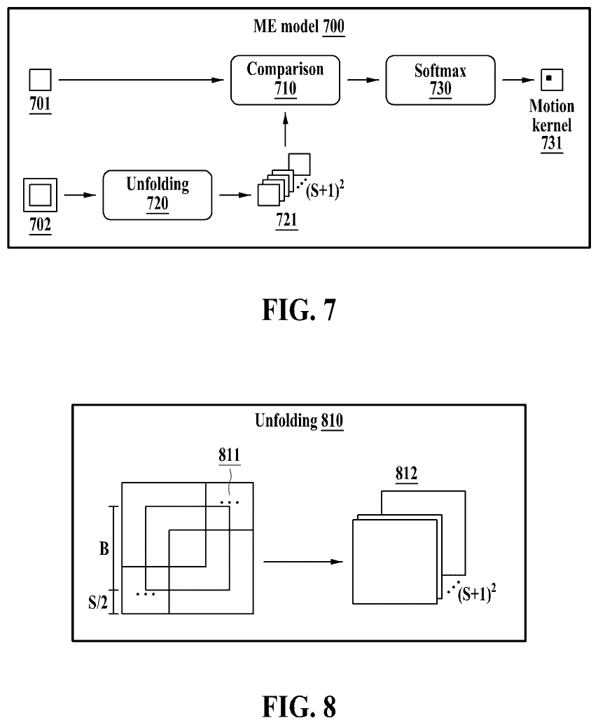

FIG. 7 is a diagram illustrating an example of a motion kernel estimation model of a frame prediction model, according to one or more embodiments. Referring to FIG. 7, patches 721 of a first size may be generated based on unfolding 720 related to a search range 702 of a second size including a block of a first size of a transformed reference training image frame. The number of patches 721 may be (S+1)². S may be a search length. The search length may be a difference between a length of one side of the block of the first size and a length of one side of the search range 702 of the second size.

Block matching may be performed based on a comparison 710 between a block 701 of a current reference image frame and the patches 721. For example, a sum of absolute differences (SAD) may be calculated between the block 701 and the patches 721 based on the comparison 710. A comparison result by the comparison 710 may be input to softmax 730 and a motion kernel 731 may be generated by an output of the softmax 730.

FIG. 8 is a diagram illustrating an example of an unfolding operation of a motion kernel estimation model, according to one or more embodiments. Referring to FIG. 8, patches 812 of a first size corresponding to a search range 811 of a second size may be generated based on unfolding 810. B may denote a length of one side of a block of the first size and S may denote a search length.

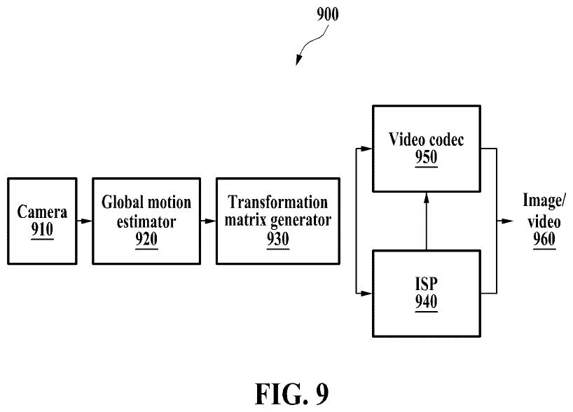

FIG. 9 is a block diagram illustrating an exemplary configuration of an electronic device, according to one or more embodiments. Referring to FIG. 9, an electronic device 900 may include a camera 910, a global motion estimator 920, a transformation matrix generator 930, an ISP 940, and a video codec 950. The electronic device 900 may further include a processor, a memory, a storage, an input/output (I/O) device, and a network interface that are not shown in FIG. 9.

The camera 910 may generate a current image frame and a reference image frame.

The global motion estimator 920 may store a neural network-based global motion estimation model. The global motion estimator 920 may estimate global motion parameters corresponding to components of a global motion between the current image frame and the reference image frame by executing the global motion estimation model based on the current image frame and the reference image frame.

The transformation matrix generator 930 may generate a geometric transformation matrix by combining the global motion parameters. According to one or more embodiments, the transformation matrix generator 930 may be implemented as hardware. For example, the transformation matrix generator 930 may include a hardware-based operation logic that combines the global motion parameters. The operation logic may provide various combinational operations for various modes of the video codec 950.

At least one of the ISP 940 and the video codec 950 may use the geometric transformation matrix. The ISP 940 may generate an output image using the geometric transformation matrix. The video codec 950 may generate an output video using the geometric transformation matrix.

For example, the ISP 940 may perform image signal processing (e.g., image stabilization) using the geometric transformation matrix (e.g., the homography transformation matrix). An output image may be generated by image signal processing. The video codec 950 may perform video encoding using the geometric transformation matrix (e.g., the affine transformation matrix). An output video may be generated. The video codec 950 may perform video encoding based on generated output images using the geometric transformation matrix (e.g., the homography transformation matrix).

According to one or more embodiments, the global motion estimator 920 may be implemented as hardware. For example, network parameters of the global motion estimation model may be stored as parameter values of a network operator of the global motion estimator 920. The global motion estimation model may perform a hardware-based network operation based on pixel values of the current image frame and the reference image frame and may generate motion parameters.

According to one or more embodiments, the global motion estimation model may include a first estimation model configured to estimate first global motion parameters and a second estimation model configured to estimate second global motion parameters. The global motion estimator 920 may include a first hardware module configured to store the first estimation model and a second hardware module configured to store the second estimation model or may include a single hardware module configured to selectively store the first estimation model and the second estimation model. The global motion estimation model may estimate the first global motion parameters and the second global motion parameters using the first hardware module and the second hardware module or may estimate the first global motion parameters and the second global motion parameters using the single hardware module.

The geometric transformation matrix may include an affine transformation matrix determined by a combination of the first global motion parameters and a homography transformation matrix determined by a combination of the second global motion parameters. The transformation matrix generator 930 may include a first operation logic configured to generate the affine transformation matrix by combining the first global motion parameters and a second operation logic configured to generate the homography transformation matrix by combining the second global motion parameters.

According to one or more embodiments, the global motion estimation model may include sub-models corresponding to at least one of a translation mode, a rotation mode, a zoom mode, a rotation and zoom mode, and an affine mode of the video codec 950. For example, the first estimation model of the global motion estimation model may include the sub-models. In this case, the global motion estimator 920 may include hardware modules configured to store the sub-models or may include a single hardware module configured to selectively store the sub-models. When the single hardware module is used, a sub-model corresponding to a current model selected from the translation mode, the rotation mode, the zoom mode, the rotation and zoom mode, and the affine mode may be loaded to the single hardware module and global motion parameters for the current mode may be estimated using the single hardware module.

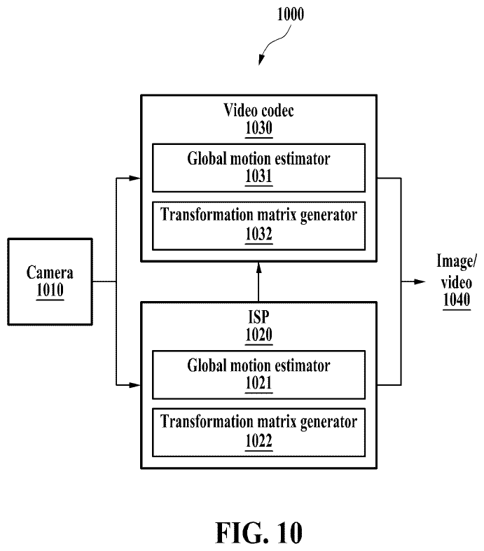

FIG. 10 is a block diagram illustrating another exemplary configuration of an electronic device, according to one or more embodiments. Referring to FIG. 10, an electronic device 1000 may include a camera 1010, an ISP 1020, and a video codec 1030. Unlike the example of FIG. 9, the ISP 1020 may include a global motion estimator 1021 and a transformation matrix generator 1022 and the video codec 1030 may include a global motion estimator 1031 and a transformation matrix generator 1032. For example, the global motion estimator 1021 and the transformation matrix generator 1022 may exist in a motion estimation area of the ISP 1020 and the global motion estimator 1031 and the transformation matrix generator 1032 may exist in a motion estimation area of the video codec 1030.

The camera 1010 may generate a current image frame and a reference image frame. The global motion estimator 1021 may include a first estimation model configured to estimate first global motion parameters. The transformation matrix generator 1022 may generate an affine transformation matrix by combining the first global motion parameters. The global motion estimator 1031 may include a second estimation model configured to estimate second global motion parameters. The transformation matrix generator 1032 may generate a homography transformation matrix by combining the second global motion parameters. An image and/or a video 1040 may be generated using the affine transformation matrix and/or the homography transformation matrix.

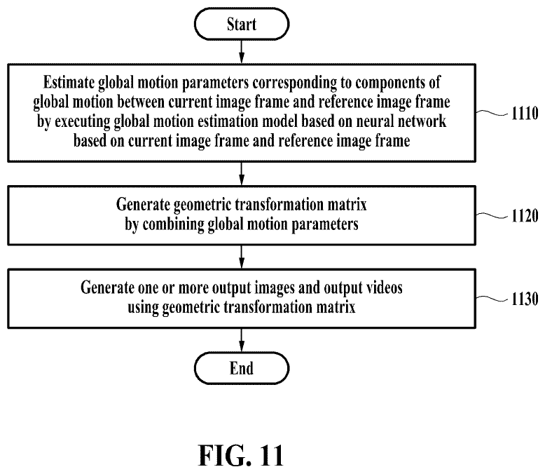

FIG. 11 is a flowchart illustrating an example of an image processing method based on global motion estimation, according to one or more embodiments. Referring to FIG. 11, in operation 1110, an electronic device may estimate global motion parameters corresponding to components of a global motion between a current image frame and a reference image frame by executing a neural network-based global motion estimation model based on the current image frame and the reference image frame. In operation 1120, the electronic device may generate a geometric transformation matrix by combining the global motion parameters. In operation 1130, the electronic device may generate at least one of an output image and an output video using the geometric transformation matrix.

Operation 1130 may include generating an output video by encoding the current image frame and the reference image frame using the geometric transformation matrix. The generating of the output video may include inputting the current image frame, the reference image frame, and the geometric transformation matrix to a video codec that supports the geometric transformation matrix.

The video codec may support at least one of a translation mode using a global translation motion, a rotation mode using a global rotation motion, a zoom mode using a global zoom motion, a rotation and zoom mode using global rotation and global zoom, and an affine mode using a global translation motion, a global rotation motion, a global zoom motion, and a global shear motion. The global motion estimation model may include sub-models corresponding to at least one of the translation mode, the rotation mode, the zoom mode, the rotation and zoom mode, and the affine mode. Operation 1110 may include estimating the global motion parameters by executing a sub-model corresponding to a current mode selected from the translation mode, the rotation mode, the zoom mode, the rotation and zoom mode, and the affine mode. The sub-models may estimate different global motion parameter sets.

The geometric transformation matrix may be an affine transformation matrix. The global motion parameters may include a translation parameter, a rotation parameter, a scale parameter, and a shear parameter.

Operation 1120 may include determining one or more function values by substituting one or more global motion parameters into one or more functions and determining elements of the geometric transformation matrix by combining the global motion parameters based on operations between the global motion parameters, operations between the global motion parameters and one or more function values, operation between a plurality of function values of the one or more function values, or a combination thereof.

Operation 1130 may include generating an output image by driving an ISP using the geometric transformation matrix.

The geometric transformation matrix may be a homography transformation matrix. The global motion parameters may include a roll angle parameter, a pitch angle parameter, and a yaw angle parameter.

The electronic device may generate a scaled current image frame and a scaled reference image frame by scaling the current image frame and the reference image frame to a target size. The global motion estimation model may be executed based on the scaled current image frame and the scaled reference image frame. The target size may be adjusted to guarantee real-timeness of video encoding.

The global motion estimation model may include a first estimation model configured to estimate first global motion parameters and a second estimation model configured to estimate second global motion parameters. The geometric transformation matrix may include an affine transformation matrix determined by a combination of the first global motion parameters and a homography transformation matrix determined by a combination of the second global motion parameters.

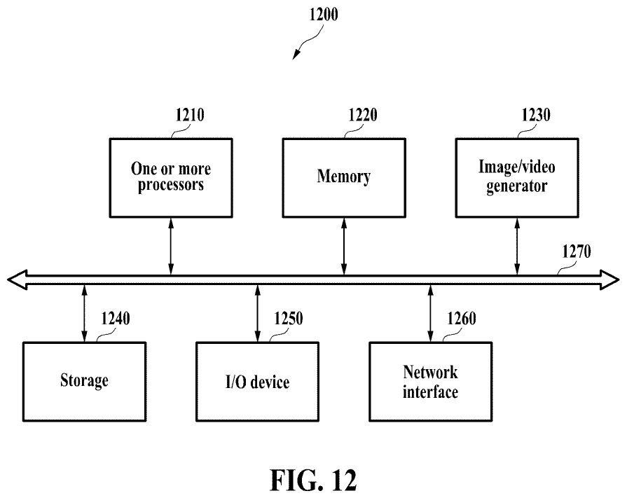

FIG. 12 is a block diagram illustrating another exemplary configuration of an electronic device, according to one or more embodiments. Referring to FIG. 12, an electronic device 1200 may include one or more processors 1210, a memory 1220, an image and/or video generator 1230, a storage 1240, an I/O device 1250, and a network interface 1260. These components may communicate with each other via a communication bus 1270. For example, the electronic device 1200 may be implemented as at least a part of a mobile device such as a mobile phone, a smart phone, a PDA, a netbook, a tablet computer or a laptop computer, a wearable device such as a smartwatch, a smart band or smart glasses, a computing device such as a desktop or a server, a home appliance such as a television, a smart television or a refrigerator, a security device such as a door lock, or a vehicle such as an autonomous vehicle or a smart vehicle, and an unmanned moving device, such as a drone or a robot.

The one or more processors 1210 may execute instructions stored in the memory 1220 or the storage 1240. When executed by the one or more processors 1210, the instructions may cause the electronic device 1200 to perform the operations described with reference to FIGS. 1 to 11. The memory 1220 may include a computer-readable storage medium or a computer-readable storage device. The memory 1220 may store instructions to be executed by the one or more processors 1210 and may store related information while software and/or an application is being executed by the electronic device 1200.

The image and/or video generator 1230 may generate an image and/or a video. For example, the image and/or the video generator 1230 may include a camera, a global motion estimator, a transformation matrix generator, an ISP, and a video codec. For example, the image and/or video generator 1230 may have the configuration of FIG. 9 or the configuration of FIG. 10. However, the example is not limited thereto.

The storage 1240 may include a computer-readable storage medium or a computer-readable storage device. The storage 1240 may store a larger quantity of information than the memory 1220 for a long time. For example, the storage 1240 may include a magnetic hard disk, an optical disc, a flash memory, a floppy disk, or other non-volatile memories known in the art.

The I/O device 1250 may receive an input from the user in traditional input manners through a keyboard and a mouse, and in new input manners such as a touch input, a voice input, and an image input. For example, the I/O device 1250 may include a keyboard, a mouse, a touch screen, a microphone, or any other device that detects the input from the user and transmits the detected input to the electronic device 1200. The I/O device 1250 may provide an output of the electronic device 1200 to the user through a visual, auditory, or haptic channel. The I/O device 1250 may include, for example, a display, a touch screen, a speaker, a vibration generator, or any other device that provides the output to the user. The network interface 1260 communicates with an external device via a wired or wireless network.

The embodiments described herein may be implemented using a hardware component, a software component and/or a combination thereof. A processing device may be implemented using one or more general-purpose or special-purpose computers, such as, for example, a processor, a controller and an arithmetic logic unit (ALU), a DSP, a microcomputer, an FPGA, a programmable logic unit (PLU), a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciate that a processing device may include multiple processing elements and multiple types of processing elements. For example, the processing device may include a plurality of processors, or a single processor and a single controller. In one or more examples, different processing configurations are possible, such as parallel processors.

The software may include a computer program, a piece of code, an instruction, or some combination thereof, to independently or collectively instruct or configure the processing device to operate as desired. Software and data may be stored in any type of machine, component, physical or virtual equipment, or computer storage medium or device capable of providing instructions or data to or being interpreted by the processing device. The software also may be distributed over network-coupled computer systems so that the software is stored and executed in a distributed fashion. The software and data may be stored by one or more non-transitory computer-readable recording mediums.

The methods according to the above-described examples may be recorded in non-transitory computer-readable media including program instructions to implement various operations of the above-described examples. The media may also include, alone or in combination with the program instructions, data files, data structures, and the like. The program instructions recorded on the media may be those specially designed and constructed for the purposes of examples, or they may be of the kind well-known and available to those having skill in the computer software arts. Examples of non-transitory computer-readable media include magnetic media such as hard disks, floppy disks, and magnetic tape; optical media such as CD-ROM discs, DVDs, and/or Blue-ray discs; magneto-optical media such as optical discs; and hardware devices that are specially configured to store and perform program instructions, such as read-only memory (ROM), random access memory (RAM), flash memory (e.g., USB flash drives, memory cards, memory sticks, etc.), and the like. Examples of program instructions include both machine code, such as produced by a compiler, and files containing higher-level code that may be executed by the computer using an interpreter.

The above-described devices may be configured to act as one or more software modules in order to perform the operations of the above-described examples, or vice versa.

As described above, although the embodiments have been described with reference to the limited drawings, a person skilled in the art may apply various technical modifications and variations based thereon. For example, suitable results may be achieved if the described techniques are performed in a different order and/or if components in a described system, architecture, device, or circuit are combined in a different manner and/or replaced or supplemented by other components or their equivalents.

Accordingly, other implementations are within the scope of the following claims.

What is claimed is:

1. A method of image processing based on global motion estimation, the method comprising:
estimating global motion parameters corresponding to components of a global motion between a current image frame and a reference image frame by executing a global motion estimation model comprising one or more neural networks that input the current image frame and the reference image frame;
generating a geometric transformation matrix by combining the global motion parameters; and
generating at least one of an output image and an output video using the geometric transformation matrix.

2. The method of claim 1, wherein the generating the at least one of the output image and the output video further comprises:
generating the output video by encoding the current image frame and the reference image frame using the geometric transformation matrix.

3. The method of claim 2, wherein the generating the at least one of the output image and the output video further comprises:
inputting the current image frame, the reference image frame, and the geometric transformation matrix into a video codec configured to execute one or more operations using the geometric transformation matrix.

4. The method of claim 3, wherein the video codec is configured to execute at least one of a translation mode using a global translation motion, a rotation mode using a global rotation motion, a zoom mode using a global zoom motion, a rotation and zoom mode using global rotation and global zoom, and an affine mode using the global translation motion, the global rotation motion, the global zoom motion, and a global shear motion.

5. The method of claim 4, wherein the global motion estimation model comprises one or more sub-models corresponding to at least one of the translation mode, the rotation mode, the zoom mode, the rotation and zoom mode, and the affine mode.

6. The method of claim 1, wherein the geometric transformation matrix is an affine transformation matrix.

7. The method of claim 1, wherein the generating of the geometric transformation matrix comprises:
determining one or more function values by substituting one or more global motion parameters into one or more functions; and
determining one or more elements of the geometric transformation matrix by combining the global motion parameters based on (i) operations between the global motion parameters, (ii) operations between the global motion parameters and the one or more function values, (iii) operations between a plurality of function values of the one or more function values, or (iv) a combination thereof.

8. The method of claim 1, wherein the generating of the at least one of the output image and the output video comprises:
generating the output image by driving an image signal processor (ISP) using the geometric transformation matrix.

9. The method of claim 1, wherein the geometric transformation matrix is a homography transformation matrix.

10. The method of claim 1, further comprising:
generating a scaled current image frame by scaling the current image frame to a target size; and
generating a scaled reference image frame by scaling the reference image frame to the target size,
wherein the global motion estimation model is executed based on the scaled current image frame and the scaled reference image frame.

11. The method of claim 10, wherein the target size is adjusted to guarantee that video encoding is performed within a predetermined amount of time.

12. The method of claim 1, wherein the global motion estimation model comprises a first estimation model configured to estimate first global motion parameters and a second estimation model configured to estimate second global motion parameters, and
the geometric transformation matrix comprises an affine transformation matrix determined by a combination of the first global motion parameters and a homography transformation matrix determined by a combination of the second global motion parameters.

13. An electronic device comprising:
a camera configured to generate a current image frame and a reference image frame;
a memory storing one or more instructions;
a video codec; and
at least one processor operatively coupled to the memory, the camera, and the video codec,
wherein the one or more instructions, when executed by the at least one processor, cause the electronic device to:
store a global motion estimation model based on a neural network and estimate global motion parameters corresponding to components of a global motion between the current image frame and the reference image frame by executing the global motion estimation model comprising one or more neural networks that input the reference image frame;
generate a geometric transformation matrix by combining the global motion parameters; and
control the video codec to generate an output video using the geometric transformation matrix.

14. The electronic device of claim 13, wherein the one or more instructions, when executed by the at least one processor, cause the electronic device to execute at least one of a translation mode supporting a global translation motion, a rotation mode supporting a global rotation motion, a zoom mode supporting a global zoom motion, a rotation and zoom mode supporting global rotation and global zoom, and an affine mode supporting the global translation motion, the global rotation motion, the global zoom motion, and a global shear motion.

15. The electronic device of claim 13, wherein the geometric transformation matrix is an affine transformation matrix.

16. The electronic device of claim 13, wherein the one or more instructions, when executed by the at least one processor cause the electronic device to, to generate the geometric transformation matrix:
determine one or more function values by substituting one or more global motion parameters into one or more functions, and
determine one or more elements of the geometric transformation matrix by combining the global motion parameters based on (i) operations between the global motion parameters, (ii) operations between the global motion parameters and the one or more function values, (iii) operations between a plurality of function values of the one or more function values, or (iv) a combination thereof.

17. The electronic device of claim 13, wherein a scaled current image frame is generated by scaling the current image frame to a target size and a scaled reference image frame is generated by scaling the reference image frame to the target size, and
wherein the global motion estimation model is executed based on the scaled current image frame and the scaled reference image frame.

18. An electronic device comprising:
a camera configured to generate a current image frame and a reference image frame;
a memory storing one or more instructions;
an image signal processor (ISP);
at least one processor operatively coupled to the memory, the camera, and the ISP;
wherein the one or more instructions, when executed by the at least one processor, cause the electronic device to:
store a global motion estimation model based on a neural network and estimate global motion parameters corresponding to components of a global motion between the current image frame and the reference image frame by executing the global motion estimation model based on the current image frame and the reference image frame;
generate a geometric transformation matrix by combining the global motion parameters; and
control the ISP to generate an output image using the geometric transformation matrix.

19. The electronic device of claim 18, wherein the one or more instructions, when executed by the at least one processor, cause the electronic device to, to generate the geometric transformation matrix:
determine one or more function values by substituting one or more global motion parameters into one or more functions, and
determine one or more elements of the geometric transformation matrix by combining the global motion parameters based on (i) operations between the global motion parameters, (ii) operations between the global motion parameters and the one or more function values, (iii) operations between a plurality of function values of the one or more function values, or (iv) a combination thereof.

20. The electronic device of claim 18, wherein the geometric transformation matrix is a homography transformation matrix.
